(19) United States
(12) Patent Application Publication
(10) Pub. No.: US 2025/0115514 A1
(43) Pub. Date: Apr. 10, 2025

(54) HIGH PERFORMANCE FIBERGLASS COMPOSITION WITH IMPROVED ELASTIC MODULUS

(71) Applicant: Owens Corning Intellectual Capital, LLC, Toledo, OH (US)

(72) Inventor: Michelle L. Korwin-Edson, Granville, OH (US)

(21) Appl. No.: 18/981,921

(22) Filed: Dec. 16, 2024

Related U.S. Application Data
(63) Continuation of application No. 17/696,110, filed on Mar. 16, 2022.
Application No. 17/696,110 is a continuation of application No. 16/686,351, filed on Nov. 18, 2019, now Pat. No. 11,306,021.
(60) Provisional application No. 62/771,250, filed on Nov. 26, 2018.

(51) Int. Cl. C03C 13/00; C03B 37/02; C03C 3/085; C03C 3/087; C03C 3/095; C03C 3/097; C08J 5/04

(52) U.S. Cl. CPC C03C 13/00; C03B 37/02; C03C 3/085; C03C 3/087; C03C 3/095; C03C 3/097; C08J 5/043; C03C 2213/00

(57) ABSTRACT

A glass composition is provided that includes SiO₂ in an amount from 50.0 to 65.0% by weight; Al₂O₃ in an amount from 18.0 to 23.0% by weight; CaO in an amount from 1 to 8.5% by weight; MgO in an amount from 9.0 to 14.0% by weight; Na₂O in an amount from 0.0 to 1.0% by weight; K₂O in an amount from 0.0 to 1.0% by weight; Li2O in an amount from 0.1 to 4.0% by weight; TiO₂ in an amount from 0.0 to 2.5% by weight, Y₂O₃ in an amount from 0 to 10.0% by weight; La₂O₃ in an amount from 0 to 10.0% by weight; Ce₂O₃ in an amount from 0 to 5.0% by weight; and Sc₂O₃ in an amount from 0 to 5.0% by weight. Glass fibers formed from the inventive composition may be used in applications that require high stiffness and have elastic modulus between 88 and 115 GPa. Such applications include woven fabrics for use in forming wind turbine blades and aerospace structures.

### RELATED APPLICATIONS

This application is a continuation of U.S. application Ser. No. 17/696,110, filed on Mar. 16, 2022, which is a continuation of U.S. application Ser. No. 16/686,351, filed on Nov. 18, 2019, now U.S. Pat. No. 11,306,021, which claims priority to U.S. Provisional Application No. 62/771,250, filed on Nov. 26, 2018, the entire disclosures of which are incorporated herein by reference.

### BACKGROUND OF THE INVENTION

Glass fibers are manufactured from various raw materials combined in specific proportions to yield a desired composition, commonly termed a “glass batch.” This glass batch may be melted in a melting apparatus and the molten glass is drawn into filaments through a bushing or orifice plate (the resultant filaments are also referred to as continuous glass fibers). A sizing composition containing lubricants, coupling agents and film-forming binder resins may then be applied to the filaments. After the sizing is applied, the fibers may be gathered into one or more strands and wound into a package or, alternatively, the fibers may be chopped while wet and collected. The collected chopped strands may then be dried and cured to form dry chopped fibers or they can be packaged in their wet condition as wet chopped fibers.

The composition of the glass batch, along with the fiberglass manufactured therefrom, is often expressed in terms of the oxides contained therein, which commonly include SiO₂, Al₂O₃, CaO, MgO, B₂O₃, Na₂O, K₂O, Fe₂O₃, TiO₂, Li₂O, and the like. Numerous types of glasses may be produced from varying the amounts of these oxides, or eliminating some of the oxides in the glass batch. Examples of such glasses that may be produced include R-glass, E-glass, S-glass, A-glass, C-glass, and ECR-glass. The glass composition controls the forming and product properties of the glass. Other characteristics of glass compositions include the raw material cost and environmental impact.

For instance, E-glass is an aluminoborosilicate glass, generally alkali-free, and commonly used in electrical applications. One advantage of E-Glass is that its liquidus temperature allows operating temperatures for producing glass fibers to be approximately 1900° F. to 2400° F. (1038° C. to 1316° C.). The ASTM classification for E-glass fiber yarns used in printed circuit boards and aerospace applications defines the composition to be 52 to 56 weight % SiO₂, 16 to 25 weight % CaO, 12 to 16 weight % Al₂O₃, 5 to 10 weight % B₂O₃, 0 to 5 weight % MgO, 0 to 2 weight % Na₂O and K₂O, 0 to 0.8 weight % TiO₂, 0.05 to 0.4 weight % Fe₂O₃ and 0 to 1.0 weight % Fluorine.

Boron-free fibers are sold under the trademark ADVANTEX® (Owens Corning, Toledo, Ohio, USA). Boron-Free fibers, such as are disclosed in U.S. Pat. No. 5,789,329, incorporated herein by reference in its entirety, offer a significant improvement in operating temperatures over boron-containing E-glass. Boron-Free glass fibers fall under the ASTM definition for E-glass fibers for use in general-use applications.

R-Glass is a family of glasses that are composed primarily of the oxides of silicon, aluminum, magnesium, and calcium with a chemical composition that produces glass fibers with a higher mechanical strength than E-Glass fibers. R-Glass has a composition that contains about 58 to about 60% by weight SiO₂, about 23.5 to about 25.5% by weight Al₂O₃, about 14 to about 17% by weight CaO plus MgO, and less than about 2% by weight of miscellaneous components. R-Glass contains more alumina and silica than E-Glass and requires higher melting and processing temperatures during fiber forming. Typically, the melting and processing temperatures for R-Glass are higher than those for E-Glass. This increase in processing temperature requires the use of a high-cost platinum-lined melter. In addition, the close proximity of the liquidus temperature to the forming temperature in R-Glass requires that the glass be fiberized at a viscosity lower than E-Glass, which is customarily fiberized at or near about 1000 poise. Fiberizing R-Glass at the customary 1000 poise viscosity would likely result in glass devitrification, which causes process interruptions and reduced productivity.

High performance glass fibers possess higher strength and stiffness, compared to traditional E-glass fibers. In particular, for some products, stiffness is crucial for modeling and performance. For example, composites, such as wind turbine blades, prepared from glass fibers with good stiffness properties would allow for longer wind turbine blades on electrical generating wind stations while keeping flexure of the blade within acceptable limits.

Additionally, high-performance glass compositions are desired that possess favorable mechanical and physical properties (e.g., elastic modulus and tensile strength), while maintaining desirable forming properties (e.g., liquidus temperature and fiberizing temperature). Elastic modulus is a measure of the fiber stiffness, defining a relationship between the stress applied to a material and the strain produced by the same material. A stiff material has a high elastic modulus and changes its shape only slightly under elastic loads. A flexible material has a low elastic modulus and changes its shape considerably.

### SUMMARY OF THE INVENTION

Various exemplary embodiments of the present inventive concepts are directed to a glass composition comprising: SiO₂ in an amount from 50.0 to 65.0% by weight; Al₂O₃ in an amount from 18.0 to 23.0% by weight; CaO in an amount from 1 to 5.0% by weight; MgO in an amount from 9.0 to 14.0% by weight; Na₂O in an amount from 0.0 to 1.0% by weight; K₂O in an amount from 0.0 to less than 1.0% by weight; Li2O in an amount from 1.0 to 4.0% by weight; TiO₂ in an amount from 0.0 to 2.5% by weight; Y₂O₃ in an amount from 0 to 10.0% by weight; La₂O₃ in an amount from 0 to 10.0% by weight; Ce₂O₃ in an amount from 0 to 5.0% by weight; and Sc₂O₃ in an amount from 0 to 5.0% by weight. The glass composition includes a total concentration of La₂O₃+Y₂O₃ in an amount from 2.0 to 10.0% by weight.

In some exemplary embodiments, the glass fiber formed from the glass composition has an elastic modulus between 88 and 115 GPa and a tensile strength according to ASTM D2343-09 of at least 4,400 MPa.

The glass composition may further include 0 to about 7.0% by weight Ta₂O₅; 0 to about 7.0% by weight Ga₂O₃; 0 to about 2.5% by weight Nb₂O₅, and 0 to about 2.0% by weight V₂O₅.

In various exemplary embodiments, the glass composition is essentially free of B₂O₃.

In various exemplary embodiments, the glass composition includes 6.0 to 10 wt. % Y₂O₃.

In various exemplary embodiments, the glass composition includes greater than 1.5 to 10 wt. % La₂O₃.

In various exemplary embodiments, the glass composition comprises 1.5 to 3.5% by weight Li₂O.

In various exemplary embodiments, the glass composition comprises a ratio of MgO/(CaO+SrO) of greater than 2.1.

In various exemplary embodiments, the composition includes at least 4% by weight of Y₂O₃, La₂O₃, Ce₂O₃, and Sc₂O₃.

Further exemplary aspects of the present inventive concepts are directed to a glass fiber formed from a composition comprising: SiO₂ in an amount from 50.0 to 65.0% by weight; Al₂O₃ in an amount from 18.0 to 23.0% by weight; CaO in an amount from 1 to 8.5% by weight; MgO in an amount from 9.0 to 14.0% by weight; Na₂O in an amount from 0.0 to 1.0% by weight; K₂O in an amount from 0.0 to less than 1.0% by weight; Li2O in an amount from 0.0 to 4.0% by weight; TiO₂ in an amount from 0.0 to 2.5% by weight, Y₂O₃ in an amount from 6.0 to 10.0% by weight; La₂O₃ in an amount from 0 to 10.0% by weight; Ce₂O₃ in an amount from 0 to 5.0% by weight; and Sc₂O₃ in an amount from 0 to 5.0% by weight. The glass fiber has an elastic modulus between 88 and 115 GPa.

In various exemplary embodiments, the composition comprises 0.5 to 3.5% by weight Li₂O.

In various exemplary embodiments, the glass composition includes greater than 1.5 to 10 wt. % La₂O₃.

In various exemplary embodiments, the glass composition comprises a ratio of MgO/(CaO+SrO) of greater than 2.1.

In various exemplary embodiments, the composition includes at least 4% by weight of Y₂O₃, La₂O₃, Ce₂O₃, and Sc₂O₃.

Further exemplary embodiments are directed to a glass fiber that has an elastic modulus of 89 to 100 GPa.

Yet further exemplary aspects of the present inventive concepts are directed to a method of forming a continuous glass fiber comprising providing a molten glass composition; and drawing the molten composition through an orifice to form a continuous glass fiber.

Yet further exemplary aspects of the present inventive concepts are directed to a reinforced composite product comprising a polymer matrix; and a plurality of glass fibers formed from a glass composition comprising SiO₂ in an amount from 50.0 to 65.0% by weight; Al₂O₃ in an amount from 18.0 to 23.0% by weight; CaO in an amount from 1 to 5.0% by weight; MgO in an amount from 9.0 to 14.0% by weight; Na₂O in an amount from 0.0 to 1.0% by weight; K₂O in an amount from 0.0 to less than 1.0% by weight; Li₂O in an amount from 1.0 to 4.0% by weight; TiO₂ in an amount from 0.0 to 2.5% by weight, Y₂O₃ in an amount from 0 to 10.0% by weight; La₂O₃ in an amount from 0 to 10.0% by weight; Ce₂O₃ in an amount from 0 to 5.0% by weight; and Sc₂O₃ in an amount from 0 to 5.0% by weight. The glass composition includes a total concentration of La₂O₃+Y₂O₃ in an amount from 2.0 to 10.0% by weight.

The glass fibers have an elastic modulus between 88 and 115 GPa and a tensile strength according to ASTM D2343-09 of at least 4,400 MPa.

In some exemplary embodiments, the reinforced composite product is in the form of a wind turbine blade.

The foregoing and other objects, features, and advantages of the invention will appear more fully hereinafter from a consideration of the detailed description that follows.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein. Moreover, any numerical value reported in the Examples may be used to define either an upper or lower end-point of a broader compositional range disclosed herein.

The present disclosure relates to a high-performance glass composition with improved elastic modulus. Such glass compositions are particularly interesting in the field of wind products, such as wind turbines that require longer blades in order to generate more energy. The longer blades require materials with higher elastic modulus in order to withstand forces applied to them without breaking. The subject glass compositions include lithium and optionally rare earth oxides. Additionally, the subject glass compositions include higher levels of magnesium and alumina than other glass compositions in this space.

The glass compositions disclosed herein are suitable for melting in traditional commercially available refractory-lined glass furnaces, which are widely used in the manufacture of glass reinforcement fibers.

The glass composition may be in molten form, obtainable by melting the components of the glass composition in a melter. The glass composition exhibits a low fiberizing temperature, which is defined as the temperature that corresponds to a melt viscosity of about 1000 Poise, as determined by ASTM C965-96 (2007). Lowering the fiberizing temperature may reduce the production cost of the glass fibers because it allows for a longer bushing life and reduced energy usage necessary for melting the components of a glass composition. Therefore, the energy expelled is generally less than the energy necessary to melt many commercially available glass formulations. Such lower energy requirements may also lower the overall manufacturing costs associated with the glass composition.

For example, at a lower fiberizing temperature, a bushing may operate at a cooler temperature and therefore does not “sag” as quickly as is typically seen. “Sag” is a phenomenon that occurs when a bushing that is held at an elevated temperature for extended periods of time loses its determined stability. Thus, by lowering the fiberizing temperature, the sag rate of the bushing may be reduced, and the bushing life can be maximized.

In some exemplary embodiments, the glass composition has a fiberizing temperature of less than 2,650° F., including fiberizing temperatures of no greater than 2,600° F., no greater than 2,550° F., no greater than 2,510° F., no greater than 2470° F., no greater than 2420° F., no greater than 2410° F., no greater than 2405° F., no greater than 2400° F., and no greater than 2390° F., and no greater than 2385° F. In some exemplary embodiments, the glass composition has a fiberizing temperature no greater than 2,600° F., such as no greater than 2,500° F., and no greater than 2,200° F. In some exemplary embodiments, the glass composition has a fiberizing temperature of at least 2,000° F., including at least 2,050° F., at least 2,075° F., at least 2,100° F., and at least 2,150° F.

Another fiberizing property of a glass composition is the liquidus temperature. The liquidus temperature is defined as the highest temperature at which equilibrium exists between liquid glass and its primary crystalline phase. The liquidus temperature, in some instances, may be measured by exposing the glass composition to a temperature gradient in a platinum-alloy boat for 16 hours (ASTM C829-81 (2005)). At all temperatures above the liquidus temperature, the glass is completely molten, i.e., it is free from crystals. At temperatures below the liquidus temperature, crystals may form.

In some exemplary embodiments, the glass composition has a liquidus temperature below 2,600° F., including liquidus temperature of no greater than 2,500° F., no greater than 2,450° F., no greater than 2,405° F., no greater than 2,350° F., no greater than 2,300° F., no greater than 2,250° F., no greater than 2,225° F., no greater than 2,200° F., no greater than 2,175° F., and no greater than 2,150° F. In some exemplary embodiments, the glass composition has a liquidus temperature between 2,050° F. and 2,550° F., including between 2,130° F., and 2,490° F., between 2,190° F. and 2,405° F., and between 2,250° F. and 2,450° F.

A third fiberizing property is “ΔT”, which is defined as the difference between the fiberizing temperature and the liquidus temperature. If the ΔT is too small, the molten glass may crystallize within the fiberizing apparatus and cause a break in the manufacturing process. Desirably, the ΔT is as large as possible for a given forming viscosity because it offers a greater degree of flexibility during fiberizing and helps to avoid devitrification both in the glass distribution system and in the fiberizing apparatus. A large ΔT additionally reduces the production cost of the glass fibers by allowing for a greater bushing life and a less sensitive forming process.

In some exemplary embodiments, the glass composition has a ΔT of at least −60° F., including at least −20° F., including at least 40° F., including at least 80° F., including at least 100° F., at least 110° F., at least 120° F., at least 135° F., at least 150° F., and at least 170° F. In various exemplary embodiments, the glass composition has a ΔT between 100° F. and 250° F., including between 120° F. and 200° F., and between 150° F. and 215° F.

The glass composition may include about 50.0 to about 65.0% by weight SiO₂, about 18.0 to about 23.0% by weight Al₂O₃, about 9.0 to about 14.0% by weight MgO, about 1.0 to about 5.0% by weight CaO, about 0.0 to about 1.0% by weight Na₂O, 0 to about 1 less than 0.0% by weight K₂O, 0 to about 2.5% by weight TiO₂, 0 to about 0.8% by weight Fe₂O₃, and about 0.0 to about 4.0% by weight Li₂O. The glass composition may further include 0 to about 10.0% by weight Y₂O₃, 0 to about 10.0% by weight La₂O₃, 0 to about 5.0% by weight Ce₂O₃, and 0 to about 5.0% by weight Sc₂O₃. The glass composition may further include 0 to about 7.0% by weight Ta₂O₅, 0 to about 7.0% by weight Ga₂O₃, 0 to about 2.5% by weight Nb₂O₅, and 0 to about 2.0% by weight V₂O₅.

In some exemplary embodiments, the glass composition may include about 52.0 to about 60.0% by weight SiO₂, about 18.4 to about 21.5% by weight Al₂O₃, about 9.3 to about 12.0% by weight MgO, about 1.5 to about 8.0% by weight CaO, about 0.01 to about 0.5% by weight Na₂O, about 0.01 to about 0.5% by weight K₂O, about 0.01 to about 2.0% by weight TiO₂, about 0.01 to about 0.6% by weight Fe₂O₃, and about 0.1 to about 3.5% by weight Li₂O. The glass composition may further include about 1.0 to about 7.0% by weight Y₂O₃, about 1.0 to about 7.0% by weight La₂O₃, about 0.01 to about 4.0% by weight Ce₂O₃, and about 0.01 to about 4.0% by weight Sc₂O₃. The glass composition may further include about 0.01 to about 5.5% by weight Ta₂O₅, about 0.1 to about 5.5% by weight Ga₂O₃, and about 0.01 to about 2.0% by weight Nb₂O₅.

The glass composition includes at least 50% by weight and no greater than 75% by weight SiO₂. In some exemplary embodiments, the glass composition includes at least 52% by weight SiO₂, including at least 55% by weight, at least 57% by weight, at least 58.5% by weight, and at least 59% by weight. In some exemplary embodiments, the glass composition includes no greater than 70% by weight SiO₂, including no greater than 68% by weight, no greater than 65.5% by weight, no greater than 64.5% by weight, no greater than 62.5% by weight, and no greater than 60.5% by weight. In some exemplary embodiments, the glass composition includes about 50% by weight to about 65% by weight, or about 52% by weight to about 60% by weight SiO₂.

To achieve both the desired mechanical and fiberizing properties, one important aspect of the glass composition is having an Al₂O₃ concentration of at least 15.0% by weight and no greater than 25% by weight. Including greater than 25% by weight Al₂O₃ causes the glass liquidus to increase to a level above the fiberizing temperature, which results in a negative ΔT. Including less than 15% by weight Al₂O₃ forms a glass fiber with an unfavorably low modulus. In some exemplary embodiments, the glass composition includes at least 18.0% by weight Al₂O₃, including at least 18.4% by weight, at least 19.0% by weight, at least 19.5% by weight, and at least 20.0% by weight. In some exemplary embodiments, the glass composition includes about 18.4 to about 23 wt. % Al₂O₃, including about 18.8 to about 21.5 wt. % Al₂O₃.

The glass composition further advantageously includes at least 8.0% by weight and no greater than 15% by weight MgO. Including greater than 15% by weight MgO will cause the liquidus temperature to increase, which also increases the glass's crystallization tendency. Including less than 8.0% by weight forms a glass fiber with an unfavorably low modulus if substituted by CaO and an unfavorable increase in viscosity if substituted with SiO₂. In some exemplary embodiments, the glass composition includes at least 9.0% by weight MgO, including at least 9.2% by weight, at least 9.3% by weight, at least 9.8% by weight, at least 10% by weight, at least 10.5% by weight, at least 11.0% by weight, at least 11.5 wt. %, at least 12.0 wt. %, and at least 13% by weight MgO. In some exemplary embodiments, the glass composition comprises an MgO concentration between about 9.0 and about 14% by weight, or between about 9.3 and about 12% by weight.

The glass composition may optionally include CaO at concentrations up to about 10.0 wt. %. Including greater than 10% by weight CaO forms a glass with a low elastic modulus. In some exemplary embodiments, the glass composition includes between 0 and 9% by weight CaO, including between 0.5 and 8.8% by weight, between 1.0 and 8.5% by weight, between 1.5 and 8.0% by weight, and between 2.0 and 7.5% by weight. In some exemplary embodiments, the glass composition includes between 1.0 and 5.0 wt. % CaO, or between 1.2 and 4.7 wt. % CaO, or between 1.3 and 4.55 wt. % CaO.

In some exemplary embodiments, the total concentration of MgO and CaO is at least 10% by weight and no greater than 22% by weight, including between 12.5% by weight and 20% by weight, and between 14% by weight and 18.5% by weight.

The glass composition may include up to about 3.0% by weight TiO₂. In some exemplary embodiments, the glass composition includes about 0% by weight to about 2.5% by weight TiO₂, including about 0.01% by weight to about 2.0% by weight and about 0.1 to about 0.75% by weight.

The glass composition may include up to about 1.0% by weight Fe₂O₃. In some exemplary embodiments, the glass composition includes 0% by weight to about 0.8% by weight Fe₂O₃, including about 0.01% by weight to about 0.6% by weight and about 0.1 to about 0.35% by weight.

The glass composition may include up to about 5.0% by weight Li₂O. In some exemplary embodiments, the glass composition includes about 0.0% by weight to about 4.0% by weight Li₂O, including about 0.1% by weight to about 3.5% by weight and about 0.5 to about 3.0% by weight. In some exemplary embodiments, the glass composition includes about 1.0 to about 4.0 wt. % Li₂O, or about 1.5 to about 3.8 wt. % Li₂O.

In some exemplary embodiments, the glass composition includes less than 2.0% by weight of the alkali metal oxides Na₂O and K₂O, including between 0 and 1.5% by weight, between 0.05 and 0.75% by weight, and between 0.1 and 0.25% by weight. The glass composition may include both Na₂O and K₂O in an amount greater than 0.01% by weight of each oxide. In some exemplary embodiments, the glass composition includes about 0 to about 1% by weight Na₂O, including about 0.01 to about 0.5% by weight, about 0.03 to about 0.3% by weight, and 0.04 to about 0.15% by weight. In some exemplary embodiments, the glass composition includes about 0 to about 1% by weight K₂O, including about 0.01 to about 0.5% by weight, about 0.03 to about 0.3% by weight, and 0.04 to about 0.15% by weight. In some exemplary embodiments, the glass composition includes less than 1.0% by weight K₂O, such as less than 0.75% by weight, or less than 0.50% by weight.

The glass composition may include up to about 1.5% by weight ZrO₂. In some exemplary embodiments, the glass composition includes about 0.01% by weight to about 1.0% by weight ZrO₂, including about 0.05% by weight to about 0.8% by weight and about 0.1 to about 0.5% by weight.

In some exemplary embodiments, the glass composition includes up to 15.0% by weight of the rare earth oxides Y₂O₃, La₂O₃, Ce₂O₃, and Sc₂O₃ (“R₂O₃”), including between 0 and 12.0% by weight, or between 1.0 and 10.0% by weight. The glass composition may include any of the R₂O₃ oxides in an amount greater than 0.01% by weight. In some exemplary embodiments, the glass composition includes about 0 to about 10% by weight Y₂O3, including about 1.0 to about 9.9% by weight, about 3.0 to about 9.5% by weight, and 6.0 to about 9.0% by weight. In some exemplary embodiments, the glass composition includes about 0 to about 10% by weight La₂O₃, including about 0.01 to about 7.5% by weight, about 0.05 to about 4.0% by weight, and 0.1 to about 3.0% by weight. In some exemplary embodiments, the glass composition includes about 0 to about 5.0% by weight Ce₂O₃, including about 0.01 to about 4.0% by weight, about 0.05 to about 2.0% by weight, and 0.1 to about 1.5% by weight. In some exemplary embodiments, the glass composition includes about 0 to about 5% by weight Sc₂O₃, including about 0.01 to about 4.0% by weight, about 0.05 to about 3.2% by weight, and 0.1 to about 3.0% by weight.

In some exemplary embodiments, the glass composition includes a total concentration of CeO₂+Sc₂O₃ that is at least 1.0% by weight, including at least 1.5% by weight, at least 1.75% by weight, at least 2.0% by weight, at least 2.1% by weight, at least 2.2% by weight, and at least 2.5% by weight.

The glass composition may include up to about 7.0% by weight Ta₂O₅. In some exemplary embodiments, the glass composition includes about 0.01% by weight to about 5.5% by weight Ta₂O₅, including about 0.05% by weight to about 3.5% by weight and about 0.1 to about 3.0% by weight.

The glass composition may include up to about 7.0% by weight Ga₂O₃. In some exemplary embodiments, the glass composition includes about 0.01% by weight to about 5.5% by weight Ga₂O₃, including about 0.05% by weight to about 5.0% by weight and about 0.1 to about 4.5% by weight.

The glass composition may include up to about 2.5% by weight Nb₂O₅. In some exemplary embodiments, the glass composition includes about 0.01% by weight to about 2.0% by weight Nb₂O₅, including about 0.05% by weight to about 1.5% by weight and about 0.1 to about 0.7% by weight.

The glass composition may include up to about 2.0% by weight V₂O₅. In some exemplary embodiments, the glass composition includes about 0.01% by weight to about 1.5% by weight V₂O₅, including about 0.05% by weight to about 1.2% by weight and about 0.1 to about 1.0% by weight.

The glass compositions may include up to about 1.0% by weight of Sm₂O₃ and/or Gd₂O₃. However, various exemplary embodiments limit the total concentration of Sm₂O₃ and Gd₂O₃ to less than 0.5% by weight, including less than 0.1% by weight, and less than 0.05% by weight.

The glass composition may include up to about 5.0% by weight ZnO. In some exemplary embodiments, the glass composition includes 0% by weight to about 2.5% by weight ZnO, including about 0.01% by weight to about 2.0% by weight and about 0.1 to about 1.0% by weight.

The inventive glass compositions may be free or substantially free of B₂O₃ and fluorine, although any may be added in small amounts to adjust the fiberizing and finished glass properties and will not adversely impact the properties if maintained below several percent. As used herein, substantially free of B₂O₃ and fluorine means that the sum of the amounts of B₂O₃ and fluorine present is less than 1.0% by weight of the composition. The sum of the amounts of B₂O₃ and fluorine present may be less than about 0.5% by weight of the composition, including less than about 0.2% by weight, less than about 0.1% by weight, and less than about 0.05% by weight.

The glass compositions may further include impurities and/or trace materials without adversely affecting the glasses or the fibers. These impurities may enter the glass as raw material impurities or may be products formed by the chemical reaction of the molten glass with furnace components. Non-limiting examples of trace materials include strontium, barium, and combinations thereof. The trace materials may be present in their oxide forms and may further include fluorine and/or chlorine. In some exemplary embodiments, the inventive glass compositions contain no more than 1.0% by weight, including less than 0.5% by weight, less than 0.2% by weight, and less than 0.1% by weight of each of BaO, SrO, P₂O₅, and SO₃. Particularly, the glass composition may include less than about 5.0% by weight of BaO, SrO, P₂O₅, and/or SO₃ combined, wherein each of BaO, SrO, P₂O₅, and SO₃ if present at all, is present in an amount of less than 1.0% by weight.

In some exemplary embodiments, the glass composition comprises a ratio of MgO/(CaO+SrO) that is at least 1.5, including at least 1.7, at least 2.0, at least 2.1, at least 2.2, and at least 2.3.

As used herein, the terms “weight percent,” “% by weight,” “wt. %,” and “percent by weight” may be used interchangeably and are meant to denote the weight percent (or percent by weight) based on the total composition.

As indicated above, the inventive glass compositions unexpectedly demonstrate an optimized elastic modulus, while maintaining desirable forming properties.

The fiber tensile strength is also referred herein simply as “strength.” In some exemplary embodiments, the tensile strength is measured on pristine fibers (i.e., unsized and untouched laboratory produced fibers) using an Instron tensile testing apparatus according to ASTM D2343-09. Exemplary glass fibers formed form the above described inventive glass composition may have a fiber tensile strength of at least 4,000 MPa, including at least 4,250 MPa, at least 4,400 MPa, at least 4,500 MPa, at least 4,800 MPa, at least 4,900 MPa, at least 4,950 MPa, at least 5,000 MPa, at least 5,100 MPa, at least 5,150 MPa, and at least 5,200 MPa. In some exemplary embodiments, the glass fibers formed from the above described composition have a fiber tensile strength of from about 4200 to about 5500 MPa, including about 4300 MPa to about 5,350 MPa, about 4,600 to about 5,315 MPa. Advantageously, the combination of compositional parameters disclosed herein makes it possible to produce glass fibers having tensile strengths of at least 4,800 MPa, including at least 4,900 MPa, and at least 5,000, which has not yet been achieved by the prior art with a glass composition having desirable fiberizing properties.

The elastic modulus of a glass fiber may be determined by taking the average measurements on five single glass fibers measured in accordance with the sonic measurement procedure outlined in the report “Glass Fiber Drawing and Measuring Facilities at the U.S. Naval Ordnance Laboratory”, Report Number NOLTR 65-87, Jun. 23, 1965.

The exemplary glass fibers formed from the inventive glass composition may have an elastic modulus of at least about 88 GPa, including at least about 89.5 GPa, at least about 90.5 GPa, at least about 91 GPa, at least about 93 GPa, at least about 95 GPa, or at least about 96 GPa. In some exemplary embodiments, the exemplary glass fibers formed from the inventive glass composition have an elastic modulus of between about 88 GPa and about 115 GPa, including between about 89 GPa and about 100 GPa, and between about 93.1 GPa and about 98 GPa.

The elastic modulus may then be used to determine the specific modulus. It is desirable to have a specific modulus as high as possible to achieve a lightweight composite material that adds stiffness to the final article. Specific modulus is important in applications where stiffness of the product is an important parameter, such as in wind energy and aerospace applications. As used herein, the specific modulus is calculated by the following equation:

Specific Modulus (MJ/kg)=Modulus (GPa)/Density (kg/cubic meter)

The exemplary glass fibers formed from the inventive glass composition has a specific modulus of about 33.0 MJ/kg to about 40.0 MJ/kg, including about 34.1 MJ/kg to about 37 MJ/kg, and about 34.5 MJ/kg to about 36.5 MJ/kg.

The density may be measured by any method known and commonly accepted in the art, such as the Archimedes method (ASTM C693-93 (2008)) on unannealed bulk glass. The glass fibers have a density of from about 2.0 to about 3.0 g/cc. In other exemplary embodiments, the glass fibers have a density of from about 2.3 to about 2.8 g/cc, including from about 2.4 to about 2.78 g/cc, and about 2.50 to about 2.75 g/cc.

According to some exemplary embodiments, a method is provided for preparing glass fibers from the glass composition described above. The glass fibers may be formed by any means known and traditionally used in the art. In some exemplary embodiments, the glass fibers are formed by obtaining raw ingredients and mixing the ingredients in the appropriate quantities to give the desired weight percentages of the final composition. The method may further include providing the inventive glass composition in molten form and drawing the molten composition through orifices in a bushing to form a glass fiber.

The components of the glass composition may be obtained from suitable ingredients or raw materials including, but not limited to, sand or pyrophyllite for SiO₂, limestone, burnt lime, wollastonite, or dolomite for CaO, kaolin, alumina or pyrophyllite for Al₂O₃, dolomite, dolomitic quicklime, brucite, enstatite, talc, burnt magnesite, or magnesite for MgO, and sodium carbonate, sodium feldspar or sodium sulfate for the Na₂O. In some exemplary embodiments, glass cullet may be used to supply one or more of the needed oxides.

The mixed batch may then be melted in a furnace or melter and the resulting molten glass is passed along a forehearth and drawn through the orifices of a bushing located at the bottom of the forehearth to form individual glass filaments. In some exemplary embodiments, the furnace or melter is a traditional refractory melter. By utilizing a refractory tank formed of refractory blocks, manufacturing costs associated with the production of glass fibers produced by the inventive composition may be reduced. In some exemplary embodiments, the bushing is a platinum alloy-based bushing. Strands of glass fibers may then be formed by gathering the individual filaments together. The fiber strands may be wound and further processed in a conventional manner suitable for the intended application.

The operating temperatures of the glass in the melter, forehearth, and bushing may be selected to appropriately adjust the viscosity of the glass, and may be maintained using suitable methods, such as control devices. The temperature at the front end of the melter may be automatically controlled to reduce or eliminate devitrification. The molten glass may then be pulled (drawn) through holes or orifices in the bottom or tip plate of the bushing to form glass fibers. In accordance with some exemplary embodiments, the streams of molten glass flowing through the bushing orifices are attenuated to filaments by winding a strand formed of a plurality of individual filaments on a forming tube mounted on a rotatable collet of a winding machine or chopped at an adaptive speed. The glass fibers of the invention are obtainable by any of the methods described herein, or any known method for forming glass fibers.

The fibers may be further processed in a conventional manner suitable for the intended application. For instance, in some exemplary embodiments, the glass fibers are sized with a sizing composition known to those of skill in the art. The sizing composition is in no way restricted, and may be any sizing composition suitable for application to glass fibers. The sized fibers may be used for reinforcing substrates such as a variety of plastics where the product's end use requires high strength and stiffness and low weight. Such applications include, but are not limited to, woven fabrics for use in forming wind turbine blades; infrastructure, such as reinforcing concrete, bridges, etc.; and aerospace structures.

In this regard, some exemplary embodiments of the present invention include a composite material incorporating the inventive glass fibers, as described above, in combination with a hardenable matrix material. This may also be referred to herein as a reinforced composite product. The matrix material may be any suitable thermoplastic or thermoset resin known to those of skill in the art, such as, but not limited to, thermoplastics such as polyesters, polypropylene, polyamide, polyethylene terephthalate, and polybutylene, and thermoset resins such as epoxy resins, unsaturated polyesters, phenolics, vinylesters, and elastomers. These resins may be used alone or in combination. The reinforced composite product may be used for wind turbine blade, rebar, pipe, filament winding, muffler filling, sound absorption, and the like.

In accordance with further exemplary embodiments, the invention provides a method of preparing a composite product as described above. The method may include combining at least one polymer matrix material with a plurality of glass fibers. Both the polymer matrix material and the glass fibers may be as described above.

### EXAMPLES

Exemplary glass compositions according to the present invention were prepared by mixing batch components in proportioned amounts to achieve a final glass composition with the oxide weight percentages set forth in Tables 1-9, below.

The raw materials were melted in a platinum crucible in an electrically heated furnace at a temperature of 1,650° C. for 3 hours.

The fiberizing temperature was measured using a rotating cylinder method as described in ASTM C965-96 (2007), entitled “Standard Practice for Measuring Viscosity of Glass Above the Softening Point,” the contents of which are incorporated by reference herein. The liquidus temperature was measured by exposing glass to a temperature gradient in a platinum-alloy boat for 16 hours, as defined in ASTM C829-81 (2005), entitled “Standard Practices for Measurement of Liquidus Temperature of Glass,” the contents of which are incorporated by reference herein. Density was measured by the Archimedes method, as detailed in ASTM C693-93 (2008), entitled “Standard Test Method for Density of Glass Buoyancy,” the contents of which are incorporated by reference herein.

The specific modulus was calculated by dividing the measured modulus in units of GPa by the density in units of kg/m³.

The strength was measured on pristine fibers using an Instron tensile testing apparatus according to ASTM D2343-09 entitled, “Standard Test Method for Tensile Properties of Glass Fiber Strands, Yarns, and Rovings Used in Reinforced Plastics,” the contents of which are incorporated by reference herein.

TABLE 1

| | Example 1 | Example 2 | Example 3 | Example 4 | Example 5 |
|---|---|---|---|---|---|
| | (% by wt.) | (% by wt.) | (% by wt.) | (% by wt.) | (% by wt.) |
| Component | | | | | |
| SiO₂ | 50.89 | 52.85 | 58 | 55.5 | 53.84 |
| Al₂O₃ | 22.92 | 20.0 | 20.00 | 21.00 | 18.42 |
| MgO | 12.46 | 10.09 | 12.00 | 11.00 | 10.28 |
| CaO | 4.47 | 8.14 | 2.00 | 3.50 | 8.29 |
| Li₂O | 2.20 | 2.00 | 2.00 | 2.00 | 2.00 |
| Fe₂O₃ | 0.01 | 0.31 | 0.00 | 0.00 | 0.32 |
| K₂O | 0.01 | 0.12 | 0.00 | 0.00 | 0.12 |
| Na₂O | 0.03 | 0.11 | 0.00 | 0.00 | 0.12 |
| TiO₂ | 0.01 | 0.63 | 0.00 | 0.00 | 0.64 |
| Sc₂O₃ | 0.00 | 0.00 | 0.00 | 0.00 | 0.00 |
| Y₂O₃ | 5.49 | 3.00 | 0.00 | 4.00 | 3.00 |
| ZrO₂ | 0.00 | 0.00 | 0.00 | 0.00 | 0.00 |
| Nb₂O₅ | 0.00 | 0.00 | 0.00 | 0.00 | 0.00 |
| La₂O₃ | 1.50 | 3.00 | 3.00 | 3.00 | 3.00 |
| Ga₂O₃ | 0.00 | 0.00 | 0.00 | 0.00 | 0.00 |
| Ta₂O₅ | 0.00 | 0.00 | 3.00 | 3.00 | 0.00 |
| V₂O₅ | 0.00 | 0.00 | 0.00 | 0.00 | 2.00 |
| Property | | | | | |
| Fiberizing | 2193 | 2191 | 2326 | 2277 | 2185 |
| Temperature | | | | | |
| (° F.) | | | | | |
| Liquidus | 2217 | 2171 | 2248 | 2293 | 2144 |
| Temperature | | | | | |
| (° F.) | | | | | |
| ΔT | −24 | 20 | 79 | −16 | 42 |
| (° F.) | | | | | |
| Density | 2.744 | 2.733 | 2.656 | 2.690 | 2.732 |
| (g/cc) | | | | | |
| Elastic | 98.0 | 94.4 | 94.3 | 94.1 | 94.1 |
| Modulus | | | | | |
| (GPa) | | | | | |
| Specific | 35.7 | 34.5 | 35.5 | 35.0 | 34.4 |
| Modulus | | | | | |
| (MJ/kg) | | | | | |
| Strength | — | — | 4919 | — | — |
| (MPa) | | | | | |

TABLE 2

| | Example 6 | Example 7 | Example 8 | Example 9 | Example 10 |
|---|---|---|---|---|---|
| | (% by wt.) | (% by wt.) | (% by wt.) | (% by wt.) | (% by wt.) |
| Component | | | | | |
| SiO₂ | 58.00 | 59.95 | 58.08 | 58.00 | 60.00 |
| Al₂O₃ | 20.00 | 19.45 | 18.84 | 19 | 20.5 |
| MgO | 12.00 | 9.62 | 9.32 | 10.50 | 12.00 |
| CaO | 2.0 | 5.13 | 4.97 | 2.00 | 1.50 |
| Li₂O | 2.00 | 1.85 | 1.79 | 1.50 | 2.00 |
| Fe₂O₃ | 0.00 | 0.00 | 0.00 | 0.00 | 0.00 |
| K₂O | 0.00 | 0.00 | 0.00 | 0.00 | 0.00 |
| Na₂O | 0.00 | 0.00 | 0.00 | 0.00 | 0.00 |
| TiO₂ | 0.00 | 0.00 | 0.00 | 0.00 | 0.00 |
| Sc₂O₃ | 0.00 | 4.00 | 0.00 | 0.00 | 0.00 |
| Y₂O₃ | 3.00 | 0.00 | 7.00 | 3.00 | 3.00 |
| ZrO₂ | 0.00 | 0.00 | 0.00 | 0.00 | 0.00 |
| Nb₂O₅ | 0.00 | 0.00 | 0.00 | 0.00 | 0.00 |
| La₂O₃ | 0.00 | 0.00 | 0.0 | 2.00 | 0.00 |
| Ga₂O₃ | 0.00 | 0.00 | 0.00 | 0.00 | 0.00 |
| Ta₂O₅ | 3.00 | 0.00 | 0.00 | 3.00 | 0.00 |
| V₂O₅ | 0.00 | 0.00 | 0.00 | 0.00 | 0.00 |
| B₂O₃ | 0.00 | 0.00 | 0.00 | 0.00 | 0.00 |
| Property | | | | | |
| Fiberizing | 2319 | 2350 | 2338 | 2369 | 2355 |
| Temperature | | | | | |
| (° F.) | | | | | |
| Liquidus | 2256 | 2405 | 2130 | 2307 | 2310 |
| Temperature | | | | | |
| (° F.) | | | | | |
| ΔT | 63 | −55 | 208 | 63 | 45 |
| (° F.) | | | | | |
| Density | 2.651 | 2.602 | 2.673 | 2.692 | 2.600 |
| (g/cc) | | | | | |
| Elastic | 93.7 | 93.5 | 93.5 | 93.4 | 93.1 |
| Modulus | | | | | |
| (GPa) | | | | | |
| Specific | 35.3 | 35.9 | 35.0 | 34.7 | 35.8 |
| Modulus | | | | | |
| (MJ/kg) | | | | | |
| Strength | 4929 | 4818 | 4830 | — | 4984 |
| (MPa) | | | | | |

TABLE 3

| | Example 11 | Example 12 | Example 13 | Example 14 | Example 15 |
|---|---|---|---|---|---|
| | (% by wt.) | (% by wt.) | (% by wt.) | (% by wt.) | (% by wt.) |
| Component | | | | | |
| SiO₂ | 58.00 | 60.50 | 59.00 | 55.60 | 60.00 |
| Al₂O₃ | 20.0 | 20.5 | 22 | 19.02 | 22.00 |
| MgO | 11.00 | 12.0 | 12.0 | 10.61 | 14.00 |
| CaO | 3.00 | 1.50 | 3.00 | 8.562 | 0.00 |
| Li₂O | 2.00 | 2.00 | 2.00 | 2.00 | 4.00 |
| Fe₂O₃ | 0.00 | 0.00 | 0.00 | 0.33 | 0.00 |
| K₂O | 0.00 | 0.00 | 0.00 | 0.12 | 0.00 |
| Na₂O | 0.00 | 0.00 | 0.00 | 0.12 | 0.00 |
| TiO₂ | 0.00 | 0.00 | 2.00 | 0.66 | 0.00 |
| Sc₂O₃ | 0.00 | 4.00 | 0.00 | 0.00 | 0.00 |
| Y₂O₃ | 3.00 | 3.50 | 0.00 | 0.00 | 0.00 |
| ZrO₂ | 1.00 | 0.00 | 0.00 | 0.00 | 0.00 |
| ZnO | 0.00 | 0.00 | 0.00 | 0.00 | 0.00 |
| Nb₂O₅ | 0.00 | 0.00 | 0.00 | 0.00 | 0.00 |
| La₂O₃ | 2.00 | 0.00 | 0.0 | 3.00 | 0.00 |
| Ga₂O₃ | 0.00 | 0.00 | 0.00 | 0.00 | 0.00 |
| Ta₂O₅ | 0.00 | 0.00 | 0.00 | 0.00 | 0.00 |
| V₂O₅ | 0.00 | 0.00 | 0.00 | 0.00 | 0.0 |
| B2O3 | 0.00 | 0.00 | 0.00 | 0.00 | 0.00 |
| Property | | | | | |
| Fiberizing | 2323 | 2367 | 2321 | 2208 | 2258 |
| Temperature | | | | | |
| (° F.) | | | | | |
| Liquidus | 2222 | 2308 | 2316 | 2152 | 2262 |
| Temperature | | | | | |
| (° F.) | | | | | |
| ΔT | 101 | 59 | 6 | 57 | −4 |
| (° F.) | | | | | |
| Density | 2.649 | 2.593 | 2.571 | 2.677 | 2.540 |
| (g/cc) | | | | | |
| Elastic | 93.0 | 92.8 | 92.8 | 92.5 | 92.4 |
| Modulus | | | | | |
| (GPa) | | | | | |
| Specific | 35.1 | 35.8 | 36.1 | 34.6 | 36.4 |
| Modulus | | | | | |
| (MJ/kg) | | | | | |
| Strength | — | 5058 | 5035 | — | 4936 |
| (MPa) | | | | | |

TABLE 4

| | Example 16 | Example 17 | Example 18 | Example 19 | Example 20 |
|---|---|---|---|---|---|
| | (% by wt.) | (% by wt.) | (% by wt.) | (% by wt.) | (% by wt.) |
| Component | | | | | |
| SiO₂ | 57.33 | 60.00 | 61.20 | 63.50 | 60.26 |
| Al₂O₃ | 19.61 | 20.00 | 19.85 | 20.50 | 19.55 |
| MgO | 10.94 | 12.00 | 9.82 | 12 | 19.67 |
| CaO | 8.83 | 2.00 | 5.23 | 2.00 | 5.15 |
| Li₂O | 2.00 | 2.00 | 1.89 | 2.00 | 1.86 |
| Fe₂O₃ | 0.34 | 0.00 | 0.00 | 0.00 | 0.00 |
| K₂O | 0.13 | 0.00 | 0.00 | 0.00 | 0.00 |
| Na₂O | 0.12 | 0.00 | 0.00 | 0.00 | 0.00 |
| TiO₂ | 0.68 | 0.00 | 0.00 | 0.00 | 0.00 |
| Sc₂O₃ | 0.00 | 0.00 | 2.00 | 0.00 | 0.00 |
| Y₂O₃ | 0.00 | 0.00 | 0.00 | 0.00 | 3.5 |
| ZrO₂ | 0.00 | 0.00 | 0.00 | 0.00 | 0.00 |
| ZnO | 0.00 | 0.00 | 0.00 | 0.00 | 0.00 |
| Nb₂O₅ | 0.00 | 0.00 | 0.00 | 0.00 | 0.00 |
| La₂O₃ | 0.00 | 0.00 | 0.00 | 0.00 | 0.00 |
| Ga₂O₃ | 0.00 | 2.00 | 0.00 | 0.00 | 0.00 |
| Ta₂O₅ | 0.00 | 2.00 | 0.00 | 0.00 | 0.00 |
| V₂O₅ | 0.00 | 0.00 | 0.00 | 0.00 | 0.00 |
| B₂O₃ | 0.00 | 0.00 | 0.00 | 0.00 | 0.00 |
| Property | | | | | |
| Fiberizing | 2236 | 2371 | 2381 | 2465 | 2378 |
| Temperature | | | | | |
| (° F.) | | | | | |
| Liquidus | 2190 | 2321 | 2235 | 2330 | 2191 |
| Temperature | | | | | |
| (° F.) | | | | | |
| ΔT | 47 | 50 | 146 | 126 | 188 |
| (° F.) | | | | | |
| Density | 2.620 | 2.596 | 2.577 | 2.546 | 2.607 |
| (g/cc) | | | | | |
| Elastic | 92.4 | 92.3 | 92.2 | 92.0 | 92.0 |
| Modulus | | | | | |
| (GPa) | | | | | |
| Specific | 35.3 | 35.5 | 35.8 | 36.1 | 35.3 |
| Modulus | | | | | |
| (MJ/kg) | | | | | |
| Strength | — | — | 5056 | 5187 | 4927 |
| (MPa) | | | | | |

TABLE 5

| | Example 21 | Example 22 | Example 23 | Example 24 | Example 25 |
|---|---|---|---|---|---|
| | (% by wt.) | (% by wt.) | (% by wt.) | (% by wt.) | (% by wt.) |
| Component | | | | | |
| SiO₂ | 59.50 | 62.00 | 58.00 | 60.00 | 60.50 |
| Al₂O₃ | 20.00 | 21.00 | 19.50 | 20.50 | 20.50 |
| MgO | 11.00 | 12.00 | 11.00 | 12.00 | 12.00 |
| CaO | 2.00 | 3.00 | 2.00 | 1.50 | 1.50 |
| Li₂O | 1.50 | 2.00 | 1.50 | 2.00 | 2.00 |
| Fe₂O₃ | 0.00 | 0.00 | 0.00 | 0.00 | 0.00 |
| K₂O | 0.00 | 0.00 | 0.00 | 0.00 | 0.00 |
| Na₂O | 0.00 | 0.00 | 0.00 | 0.00 | 0.00 |
| TiO₂ | 0.00 | 0.00 | 0.00 | 0.00 | 0.00 |
| Sc₂O₃ | 0.00 | 0.00 | 0.00 | 0.00 | 0.00 |
| Y₂O₃ | 0.00 | 0.00 | 0.00 | 0.00 | 0.00 |
| ZrO₂ | 0.00 | 0.00 | 0.00 | 1.00 | 0.00 |
| ZnO | 0.00 | 0.00 | 0.00 | 0.00 | 0.00 |
| Nb₂O₅ | 0.00 | 0.00 | 0.00 | 0.00 | 0.00 |
| La₂O₃ | 0.00 | 0.00 | 0.0 | 3.00 | 3.50 |
| Ga₂O₃ | 0.00 | 0.00 | 4.00 | 0.00 | 0.00 |
| Ta₂O₅ | 6.00 | 0.00 | 4.00 | 0.0 | 0.00 |
| V₂O₅ | 0.00 | 0.00 | 0.00 | 0.00 | 0.00 |
| B₂O₃ | 0.00 | 0.00 | 0.00 | 0.00 | 0.00 |
| Property | | | | | |
| Fiberizing | 2429 | 2420 | 2393 | 2360 | 2367 |
| Temperature | | | | | |
| (° F.) | | | | | |
| Liquidus | 2367 | 2310 | 2360 | 2289 | 2310 |
| Temperature | | | | | |
| (° F.) | | | | | |
| ΔT | 62 | 111 | 33 | 71 | 57 |
| (° F.) | | | | | |
| Density | 2.631 | 2.545 | 2.655 | 2.597 | 2.597 |
| (g/cc) | | | | | |
| Elastic | 91.9 | 91.9 | 91.9 | 91.8 | 91.7 |
| Modulus | | | | | |
| (GPa) | | | | | |
| Specific | 34.9 | 36.1 | 34.6 | 35.4 | 35.3 |
| Modulus | | | | | |
| (MJ/kg) | | | | | |
| Strength | — | 5234 | — | 4953 | 4959 |
| (MPa) | | | | | |

TABLE 6

| | Example 26 | Example 27 | Example 28 | Example 29 | Example 30 |
|---|---|---|---|---|---|
| | (% by wt.) | (% by wt.) | (% by wt.) | (% by wt.) | (% by wt.) |
| Component | | | | | |
| SiO₂ | 59.30 | 61.00 | 63.00 | 62.50 | 62.40 |
| Al₂O₃ | 20.00 | 20.50 | 21.00 | 20.50 | 20.30 |
| MgO | 10.00 | 12.00 | 12.00 | 12.00 | 12.00 |
| CaO | 4.00 | 2.50 | 2.00 | 3.00 | 3.30 |
| Li₂O | 1.70 | 2.00 | 2.00 | 2.00 | 2.00 |
| Fe₂O₃ | 0.00 | 0.00 | 0.00 | 0.00 | 0.00 |
| K₂O | 0.00 | 0.00 | 0.00 | 0.00 | 0.00 |
| Na₂O | 0.00 | 0.00 | 0.00 | 0.00 | 0.00 |
| TiO₂ | 0.00 | 0.00 | 0.00 | 0.00 | 0.00 |
| Sc₂O₃ | 0.00 | 0.00 | 0.00 | 0.00 | 0.00 |
| Y₂O₃ | 0.00 | 0.00 | 0.00 | 0.00 | 0.00 |
| ZrO₂ | 0.00 | 0.00 | 0.00 | 0.00 | 0.00 |
| ZnO | 0.00 | 0.00 | 0.00 | 0.00 | 0.00 |
| Nb₂O₅ | 0.00 | 0.00 | 0.00 | 0.00 | 0.00 |
| La₂O₃ | 2.00 | 0.00 | 0.00 | 0.00 | 0.00 |
| Ga₂O₃ | 0.00 | 0.00 | 0.00 | 0.00 | 0.00 |
| Ta₂O₅ | 5.00 | 2.00 | 0.00 | 0.00 | 0.00 |
| V₂O₅ | 0.00 | 0.00 | 0.00 | 0.00 | 0.00 |
| B₂O₃ | 0.00 | 0.00 | 0.00 | 0.00 | 0.00 |
| Property | | | | | |
| Fiberizing | 2398 | 2380 | 2459 | 2398 | 2388 |
| Temperature | | | | | |
| (° F.) | | | | | |
| Liquidus | 2289 | 2287 | 2341 | 2281 | 2268 |
| Temperature | | | | | |
| (° F.) | | | | | |
| ΔT | 109 | 94 | 119 | 117 | 121 |
| (° F.) | | | | | |
| Density | 2.629 | 2.571 | 2.529 | 2.543 | 2.540 |
| (g/cc) | | | | | |
| Elastic | 91.6 | 91.6 | 91.6 | 91.6 | 91.6 |
| Modulus | | | | | |
| (GPa) | | | | | |
| Specific | 34.8 | 35.6 | 36.2 | 36.0 | 36.0 |
| Modulus | | | | | |
| (MJ/kg) | | | | | |
| Strength | 4934 | — | 5224 | 5197 | 5026 |
| (MPa) | | | | | |

TABLE 7

| | Example 31 | Example 32 | Example 33 | Example 34 | Example 35 |
|---|---|---|---|---|---|
| | (% by wt.) | (% by wt.) | (% by wt.) | (% by wt.) | (% by wt.) |
| Component | | | | | |
| SiO₂ | 61.00 | 58.08 | 58.30 | 64.50 | 64.00 |
| Al₂O₃ | 20.00 | 18.84 | 20.00 | 20.50 | 21.00 |
| MgO | 11.50 | 9.32 | 11.00 | 12.00 | 12.00 |
| CaO | 2.00 | 4.97 | 4.00 | 1.00 | 1.00 |
| Li₂O | 1.50 | 1.79 | 2.00 | 2.00 | 2.00 |
| Fe₂O₃ | 0.00 | 0.00 | 0.00 | 0.00 | 0.00 |
| K₂O | 0.00 | 0.00 | 0.00 | 0.00 | 0.00 |
| Na₂O | 0.00 | 0.00 | 0.00 | 0.00 | 0.00 |
| TiO₂ | 0.00 | 0.00 | 0.70 | 0.00 | 0.00 |
| Sc₂O₃ | 0.00 | 0.00 | 0.00 | 0.00 | 0.00 |
| Y₂O₃ | 0.00 | 0.00 | 3.00 | 0.00 | 0.00 |
| ZrO₂ | 0.00 | 0.00 | 0.00 | 0.00 | 0.00 |
| ZnO | 0.00 | 0.00 | 1.00 | 0.00 | 0.00 |
| Nb₂O₅ | 0.00 | 0.00 | 0.00 | 0.00 | 0.00 |
| La₂O₃ | 0.00 | 7.00 | 0.0 | 0.00 | 0.00 |
| Ga₂O₃ | 0.00 | 0.00 | 0.00 | 0.00 | 0.00 |
| Ta₂O₅ | 4.00 | 0.00 | 0.00 | 0.0 | 0.00 |
| V₂O₅ | 0.00 | 0.00 | 0.00 | 0.00 | 0.00 |
| B₂O₃ | 0.00 | 0.00 | 0.00 | 0.00 | 0.00 |
| Property | | | | | |
| Fiberizing | 2380 | 2352 | 2306 | 2510 | 2481 |
| Temperature | | | | | |
| (° F.) | | | | | |
| Liquidus | 2374 | 2167 | 2169 | 2387 | 2387 |
| Temperature | | | | | |
| (° F.) | | | | | |
| ΔT | 7 | 186 | 138 | 123 | 115 |
| (° F.) | | | | | |
| Density | 2.593 | 2.683 | 2.628 | 2.522 | 2.517 |
| (g/cc) | | | | | |
| Elastic | 91.5 | 91.5 | 91.5 | 91.4 | 91.4 |
| Modulus | | | | | |
| (GPa) | | | | | |
| Specific | 35.3 | 34.1 | 34.8 | 36.3 | 36.3 |
| Modulus | | | | | |
| (MJ/kg) | | | | | |
| Strength | — | 4850 | — | 5315 | 5132 |
| (MPa) | | | | | |

TABLE 8

| | Example 36 | Example 37 | Example 38 | Example 39 | Example 40 |
|---|---|---|---|---|---|
| | (% by wt.) | (% by wt.) | (% by wt.) | (% by wt.) | (% by wt.) |
| Component | | | | | |
| SiO₂ | 61.00 | 61.00 | 60.26 | 61.00 | 59.30 |
| Al₂O₃ | 20.50 | 20.50 | 19.55 | 20.00 | 20.00 |
| MgO | 12.00 | 12.00 | 9.67 | 11.50 | 10.00 |
| CaO | 2.50 | 2.50 | 5.15 | 2.00 | 3.00 |
| Li₂O | 2.00 | 2.00 | 1.86 | 1.50 | 1.70 |
| Fe₂O₃ | 0.00 | 0.00 | 0.00 | 0.00 | 0.00 |
| K₂O | 0.00 | 0.00 | 0.00 | 0.00 | 0.00 |
| Na₂O | 0.00 | 0.00 | 0.00 | 0.00 | 0.00 |
| TiO₂ | 0.00 | 0.00 | 0.00 | 0.00 | 0.00 |
| Sc₂O₃ | 0.00 | 0.00 | 0.00 | 0.00 | 0.00 |
| Y₂O₃ | 0.00 | 0.00 | 0.00 | 0.00 | 0.00 |
| ZrO₂ | 0.00 | 0.00 | 0.00 | 0.00 | 0.00 |
| ZnO | 0.00 | 0.00 | 0.00 | 0.00 | 0.00 |
| Nb₂O₅ | 0.00 | 2.00 | 0.00 | 0.00 | 0.00 |
| La₂O₃ | 0.00 | 0.00 | 3.50 | 0.00 | 0.00 |
| Ga₂O₃ | 0.00 | 2.00 | 0.00 | 4.00 | 3.00 |
| Ta₂O₅ | 0.00 | 0.00 | 0.00 | 0.0 | 3.00 |
| V₂O₅ | 0.00 | 0.00 | 0.00 | 0.00 | 0.00 |
| B₂O₃ | 0.00 | 0.00 | 0.00 | 0.00 | 0.00 |
| Property | | | | | |
| Fiberizing | 2356 | 2375 | 2388 | 2423 | 2412 |
| Temperature | | | | | |
| (° F.) | | | | | |
| Liquidus | 2317 | 2299 | 2185 | 2376 | 2336 |
| Temperature | | | | | |
| (° F.) | | | | | |
| ΔT | 40 | 77 | 203 | 48 | 76 |
| (° F.) | | | | | |
| Density | 2.558 | 2.562 | 2.612 | 2.577 | 2.619 |
| (g/cc) | | | | | |
| Elastic | 91.3 | 91.3 | 91.1 | 91.1 | 91.1 |
| Modulus | | | | | |
| (GPa) | | | | | |
| Specific | 35.7 | 35.6 | 34.9 | 35.3 | 34.8 |
| Modulus | | | | | |
| (MJ/kg) | | | | | |
| Strength | — | — | 4948 | — | 4875 |
| (MPa) | | | | | |

TABLE 9

| | Example 41 | Example 42 | Example 43 | Example 44 | Example 45 |
|---|---|---|---|---|---|
| | (% by wt.) | (% by wt.) | (% by wt.) | (% by weight) | (% by weight) |
| Component | | | | | |
| SiO₂ | 59.50 | 59.95 | 61.82 | 58.60 | 58.60 |
| Al₂O₃ | 20.00 | 19.45 | 20.06 | 19.30 | 19.80 |
| MgO | 11.00 | 9.62 | 9.92 | 9.50 | 9.30 |
| CaO | 2.00 | 5.13 | 5.29 | 4.30 | 4.00 |
| Li₂O | 1.50 | 1.85 | 1.91 | 1.80 | 1.80 |
| Fe₂O₃ | 0.00 | 0.00 | 0.00 | 0.00 | 0.00 |
| K₂O | 0.00 | 0.00 | 0.00 | 0.00 | 0.00 |
| Na₂O | 0.00 | 0.00 | 0.00 | 0.00 | 0.00 |
| TiO₂ | 0.00 | 0.00 | 0.00 | 0.00 | 0.00 |
| Sc₂O₃ | 0.00 | 0.00 | 0.00 | 0.00 | 0.00 |
| Y₂O₃ | 0.00 | 0.00 | 0.00 | 6.50 | 6.50 |
| ZrO₂ | 0.00 | 0.00 | 1.00 | 0.00 | 0.00 |
| ZnO | 0.00 | 0.00 | 0.00 | 0.00 | 0.00 |
| Nb₂O₅ | 0.00 | 0.00 | 0.00 | 0.00 | 0.00 |
| La₂O₃ | 0.00 | 0.00 | 0.00 | 0.00 | 0.00 |
| Ga₂O₃ | 6.00 | 0.00 | 0.00 | 0.00 | 0.00 |
| Ta₂O₅ | 0.00 | 0.00 | 0.00 | 0.00 | 0.00 |
| V₂O₅ | 0.00 | 0.00 | 0.00 | 0.00 | 0.00 |
| Ce₂O₃ | 0.00 | 4.00 | 0.00 | 0.00 | 0.00 |
| B₂O₃ | 0.00 | 0.00 | 0.00 | 0.00 | 0.00 |
| Property | | | | | |
| Fiberizing | 2408 | 2373 | 2443 | 2332 | 2346 |
| Temperature | | | | | |
| (° F.) | | | | | |
| Liquidus | 2380 | 2205 | 2230 | 2195 | 2208 |
| Temperature | | | | | |
| (° F.) | | | | | |
| ΔT | 28 | 168 | 213 | 138 | 138 |
| (° F.) | | | | | |
| Density | 2.605 | 2.619 | 2.559 | 2.655 | 2.651 |
| (g/cc) | | | | | |
| Elastic | 91.0 | 91.0 | 91.0 | 93.1 | 93.1 |
| Modulus | | | | | |
| (GPa) | | | | | |
| Specific | 35 | 34.7 | 35.5 | 35.1 | 35.1 |
| Modulus | | | | | |
| (MJ/kg) | | | | | |
| Strength | — | 4913 | 5016 | — | — |
| (MPa) | | | | | |

TABLE 10

| | Example 46 | Example 47 | Example 48 | Comparative |
|---|---|---|---|---|
| | (% by wt.) | (% by wt.) | (% by weight) | Example |
| Component | | | | |
| SiO₂ | 58.60 | 58.00 | 59.00 | 60.70 |
| Al₂O₃ | 19.55 | 19.53 | 19.07 | 15.80 |
| MgO | 9.30 | 10.74 | 10.49 | 8.00 |
| CaO | 4.25 | 3.91 | 3.81 | 13.40 |
| Li₂O | 1.80 | 1.95 | 1.91 | 0.75 |
| Fe₂O₃ | 0.00 | 0.00 | 0.00 | 0.27 |
| K₂O | 0.00 | 0.00 | 0.00 | 0.10 |
| Na₂O | 0.00 | 0.00 | 0.00 | 0.23 |
| TiO₂ | 0.00 | 0.00 | 0.00 | 0.48 |
| Sc₂O₃ | 0.00 | 0.00 | 0.00 | — |
| Y₂O₃ | 6.50 | 3.91 | 3.81 | — |
| ZrO₂ | 0.00 | 0.00 | 0.00 | — |
| ZnO | 0.00 | 0.00 | 0.00 | — |
| Nb₂O₅ | 0.00 | 0.00 | 0.00 | — |
| La₂O₃ | 0.00 | 0.00 | 1.91 | — |
| Ga₂O₃ | 0.00 | 0.00 | 0.00 | — |
| Ta₂O₅ | 0.00 | 0.00 | 0.00 | — |
| V₂O₅ | 0.00 | 0.00 | 0.00 | — |
| Ce₂O₃ | 0.00 | 0.00 | 0.00 | — |
| B₂O₃ | 0.00 | 0.00 | 0.00 | — |
| Property | | | | |
| Fiberizing | 2340 | 2312 | 2332 | 2324 |
| Temperature | | | | |
| (° F.) | | | | |
| Liquidus | 2183 | 2166 | 2185 | 2140 |
| Temperature | | | | |
| (° F.) | | | | |
| ΔT | 158 | 147 | 148 | 184 |
| (° F.) | | | | |
| Density | 2.652 | 2.653 | 2.641 | 2.614 |
| (g/cc) | | | | |
| Elastic | 92.9 | 92.8 | 92.4 | 87.5 |
| Modulus | | | | |
| (GPa) | | | | |
| Specific | 35 | 35 | 35 | 33.5 |
| Modulus | | | | |
| (MJ/kg) | | | | |
| Strength | — | — | — | 4637 |
| (MPa) | | | | |

Tables 1-10 illustrate the improvement in elastic modulus that the inventive glass compositions have over commercial high-performance glass (Comparative Example). The Comparative Example demonstrates an elastic modulus of 87.5 GPa, which is below the minimum elastic modulus seen from any of the inventive compositions. Instructively, each of the inventive compositions demonstrate an elastic modulus of at least 88 GPa, and more specifically at least 90 GPa.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A glass composition comprising:
SiO₂ in an amount from 50 to 68% by weight;
Al₂O₃ in an amount from 19 to 25% by weight;
CaO in an amount from 1 to 10% by weight;
MgO in an amount from 8 to 15% by weight;
Na₂O in an amount from 0.0 to 1.0% by weight;
K₂O in an amount from 0.0 to less than 1.0% by weight;
Li₂O in an amount from 0.0 to 4.0% by weight;
TiO₂ in an amount from 0.0 to 2.5% by weight,
Y₂O₃ in an amount of at least 1% by weight;
La₂O₃ in an amount from 0 to 4% by weight; and
a total concentration of La₂O₃+Y₂O₃ in an amount from 2.0 to 15% by weight, wherein a glass fiber formed from said glass composition has an elastic modulus between 88 and 115 GPa, a tensile strength according to ASTM D2343-09 of at least 4,400 MPa, and a liquidus temperature of no greater than 2,600° F.

2. The glass composition of claim 1, further including:
0 to about 5% by weight Ce2O3;
0 to about 5% by weight Sc2O3;
0 to about 7.0% by weight Ta₂O₅;
0 to about 7.0% by weight Ga₂O₃;
0 to about 2.5% by weight Nb₂O₅, and
0 to about 2.0% by weight V₂O₅.

3. The glass composition according to claim 1, wherein said composition includes a total of at least 1% by weight Sc2O3 and Ce2O3.

4. The glass composition according to claim 1, wherein the composition includes 6.0 to 10 wt. % Y₂O₃.

5. The glass composition according to claim 1, wherein the composition includes 0.1 to 3 wt. % La₂O₃.

6. The glass composition according to claim 1, wherein the composition comprises a ratio of MgO/(CaO+SrO) of greater than 2.1.

7. The glass composition according to claim 1, wherein the composition is essentially free of B₂O₃.

8. The glass composition according to claim 1, wherein the composition comprises 0.1 to 3.5% by weight Li₂O.

9. The glass composition according to claim 1, wherein the composition includes at least 4% by weight of Y₂O₃, La₂O₃, Ce₂O₃, and Sc₂O₃.

10. The glass composition according to claim 1, wherein a glass fiber formed from the composition has an elastic modulus of at least 94.1 GPa.

11. A glass fiber formed from a composition comprising:
SiO₂ in an amount from 50 to 68% by weight;
Al₂O₃ in an amount from 19 to 25% by weight;
CaO in an amount from 1 to 10% by weight;
MgO in an amount from 8 to 15% by weight;
Na₂O in an amount from 0.0 to 1.0% by weight;
K₂O in an amount from 0.0 to less than 1.0% by weight;
Li₂O in an amount from 0.0 to 4.0% by weight;
TiO₂ in an amount from 0.0 to 2.5% by weight,
Y₂O₃ in an amount of at least 1% by weight;
La₂O₃ in an amount from 0 to 4% by weight; and
a total concentration of La₂O₃+Y₂O₃ in an amount from 2.0 to 15% by weight, wherein the glass fiber has an elastic modulus between 88 and 115 GPa and a tensile strength according to ASTM D2343-09 of at least 4,000 MPa.

12. The glass fiber according to claim 11, wherein the composition comprises 19.5 to 21.5% by weight Al₂O₃.

13. The glass fiber according to claim 11, wherein the composition includes greater than 0.1 to 3 wt. % La₂O₃.

14. The glass fiber according to claim 11, wherein the composition comprises a ratio of MgO/(CaO+SrO) of greater than 2.1.

15. The glass fiber according to claim 11, wherein the composition is essentially free of B₂O₃.

16. The glass fiber according to claim 11, wherein the composition comprises 0.1 to 3.5% by weight Li₂O.

17. The glass fiber according to claim 11, wherein the glass fiber has an elastic modulus of at least 94.1 GPa.

18. A method of forming a continuous glass fiber comprising:
providing a molten composition according to claim 1; and
drawing said molten composition through an orifice to form a continuous glass fiber.

19. A reinforced composite product comprising;
a polymer matrix; and
a plurality of glass fibers formed from a glass composition comprising:
SiO₂ in an amount from 50 to 68% by weight;
Al₂O₃ in an amount from 19 to 25% by weight;
CaO in an amount from 1 to 10% by weight;
MgO in an amount from 8 to 15% by weight;
Na₂O in an amount from 0.0 to 1.0% by weight;
K₂O in an amount from 0.0 to less than 1.0% by weight;
Li₂O in an amount from 0.0 to 4.0% by weight;
TiO₂ in an amount from 0.0 to 2.5% by weight,
Y₂O₃ in an amount of at least 1% by weight;
La₂O₃ in an amount from 0 to 4% by weight; and a total concentration of La₂O₃+Y₂O₃ in an amount from 2.0 to 15% by weight, wherein the glass fibers have an elastic modulus between 88 and 115 GPa, and a tensile strength according to ASTM D2343-09 of at least 4,400 MPa.

20. A reinforced composite product according to claim 19, wherein said reinforced composite product is in the form of a wind turbine blade.
